(19) United States
(12) Patent Application Publication
(10) Pub. No.: US 2024/0174157 A1
(43) Pub. Date: May 30, 2024

(54) MOVEMENT APPARATUS

(71) Applicant: IPHK Pty Ltd, Slacks Creek (AU)

(72) Inventor: Jason CEREZO, Slacks Creek (AU)

(21) Appl. No.: 18/165,465

(22) Filed: Feb. 7, 2023

(30) Foreign Application Priority Data
Nov. 29, 2022 (AU) 2022279393

(51) Int. Cl. B60N 3/10

(52) U.S. Cl. CPC B60N 3/104

(57) ABSTRACT

A movement apparatus is disclosed. The movement apparatus comprises a base and a mounting structure operatively mounted to the base and moveable with respect to the base. The mounting structure is adapted to securely locate an item. Movement of the mounting structure with respect to the base is operable to move the movement apparatus between a storage position and a use position, whereby in the use position the item securely located on the mounting structure is displaced vertically, horizontally and rotationally from the storage position.

### FIELD OF THE INVENTION

The present invention relates to a movement apparatus. The invention is particularly related to, although not exclusively, with a movement apparatus for moving an item, such as a fridge, from a storage location, suitably within the confines of a vehicle, and a use position to enable convenient access to the item.

### BACKGROUND OF THE INVENTION

Recreational activities such as caravanning, camping, campervanning and four-wheel driving are popular pursuits more generally and are particularly popular with retirees and elderly people.

It is desirable in these activities to ensure that certain comforts are transported along when these activities are being pursued. For example, when travelling in a four-wheel drive or campervan to a remote location, it is well known to take a fridge along whereby the fridge is operable off a battery, a generator or the vehicle's power. Given that space is at a premium, the fridge is often transported in a storage location that is not conveniently accessible for use.

Furthermore, the boot of a four-wheel drive and/or the tray of a truck or ute is often located above the ground at a height that makes it difficult if not impossible for a person to access easily whilst standing next to the vehicle.

Moving the fridge to a use location from a storage location without any assistance is often impractical due to the size and weight of the fridge. As such, there are known apparatus that are able to move the fridge from a storage location in the boot of a 4wd or a tray of a ute or truck to a use location whereby easy access to the fridge is possible. These apparatus often use a combination of slide assemblies to move the fridge out of the storage assembly and then lower the fridge to a suitable height. Sometimes, these assemblies are referred to as “fridge slides” or “drop down fridge slides” in the art.

Any discussion of documents, acts, materials, devices, articles or the like which have been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### OBJECT OF THE INVENTION

It is an object of the invention to overcome or at least alleviate one or more of the above problems and/or provide the consumer with a useful or commercial choice.

Other preferred objects of the present invention will become apparent from the following description.

### SUMMARY OF THE INVENTION

In one form, although it need not be the only or indeed the broadest form, the invention resides in a movement apparatus comprising:
a base; and
a mounting structure operatively mounted to the base and moveable with respect to the base, the mounting structure adapted to securely locate an item;
wherein movement of the mounting structure with respect to the base is operable to move the movement apparatus between a storage position and a use position, whereby in the use position the item is displaced vertically, horizontally and rotationally from the storage position.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1A shows a perspective view of a movement apparatus according to an embodiment of the invention in a storage position;

FIG. 1B shows a upper rear perspective view of the movement apparatus shown in FIG. 1A carrying a fridge;

FIG. 1C shows a lower front perspective view of the movement apparatus shown in FIG. 1A carrying a fridge;

FIG. 2 shows a partial front perspective view of a shelf structure forming part of the movement apparatus shown in FIG. 1A;

FIG. 3 shows a perspective view of a translation structure forming part of the movement apparatus shown in FIG. 1A;

FIG. 4A shows a perspective view of mounting structure forming part of the movement apparatus shown in FIG. 1A;

FIG. 4B shows an end view of the mounting structure shown in FIG. 4A;

FIG. 5A shows a perspective view of the movement apparatus shown in FIG. 1A in a first intermediate position;

FIG. 5B shows a perspective view of the movement apparatus shown in FIG. 1A in a second intermediate position; and

FIG. 5C shows a perspective view of the movement apparatus shown in FIG. 1A in a use position.

### DETAILED DESCRIPTION OF THE DRAWINGS

The present invention has been described in the embodiment as a movement apparatus moveable between a storage position and a use position in order that a fridge is moved from a storage location on a vehicle to a use location. A skilled addressee will appreciate that the movement apparatus of the invention may be employed to move other items such as a toolbox, a storage compartment, a generator and the like.

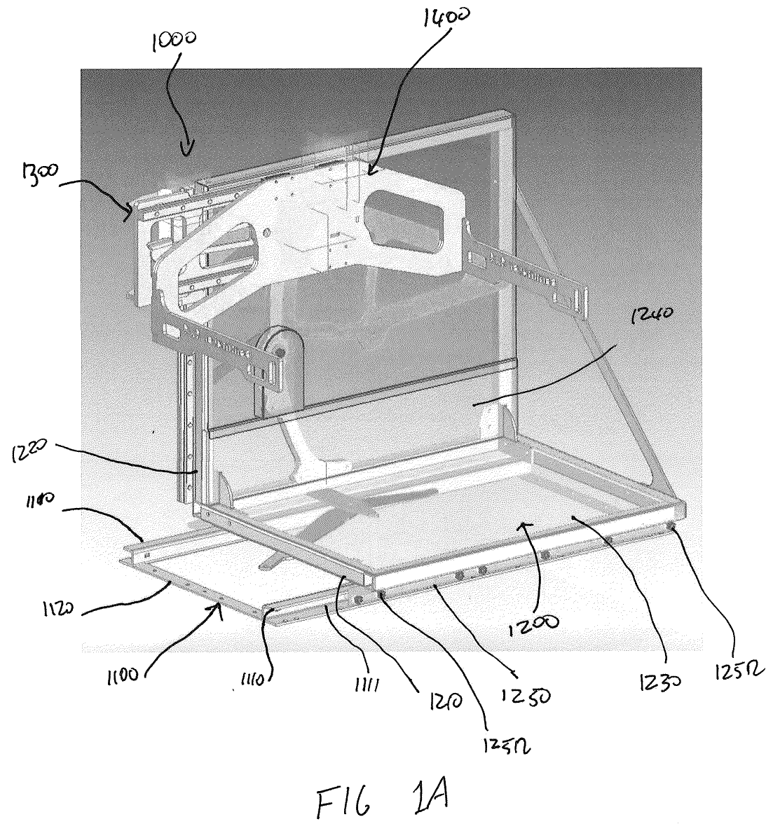

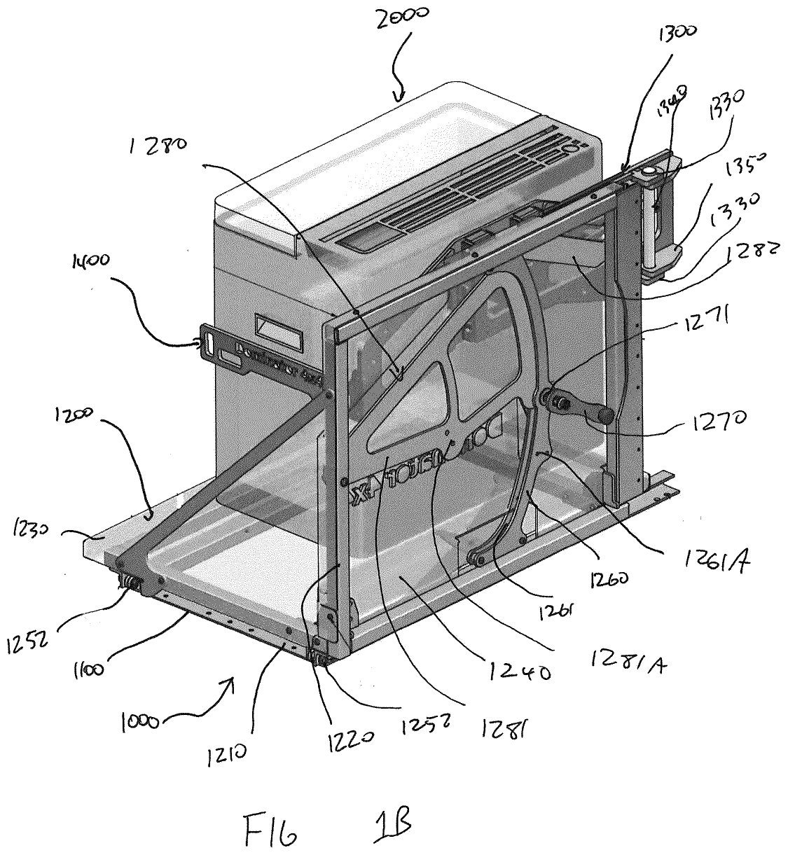

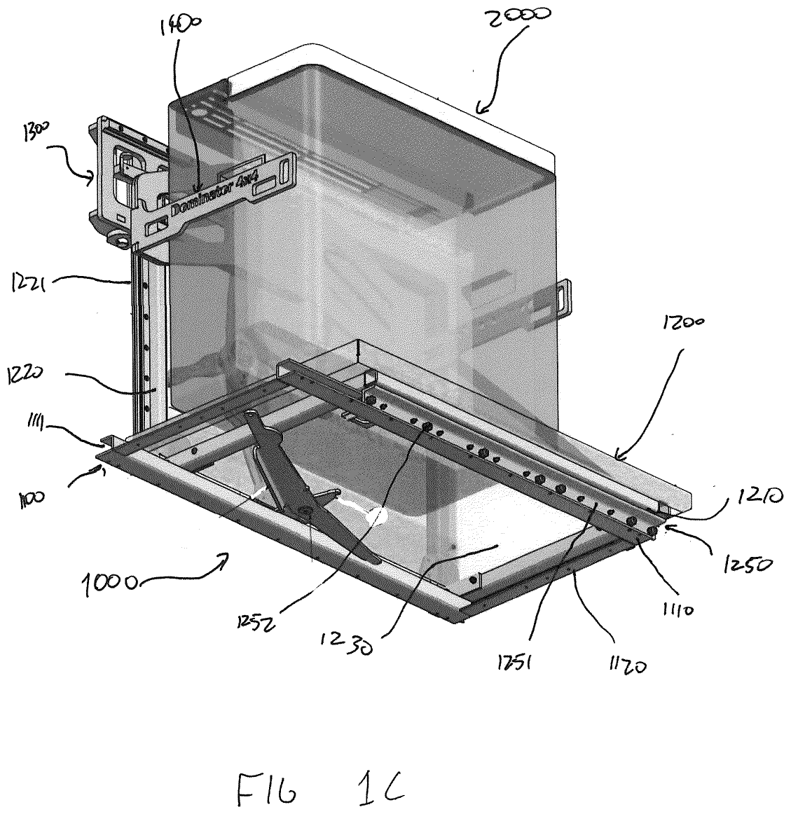

FIG. 1A shows a perspective view of a movement apparatus 1000 according to an embodiment of the invention in a storage position. FIG. 1B shows an upper rear perspective view of movement apparatus 1000 shown in carrying an item which, in the embodiment, is a fridge 2000. FIG. 1C shows a lower front perspective view of movement apparatus 1000 carrying fridge 2000.

Movement apparatus 1000 is moveable between a storage position and a use position as will be discussed in greater detail below.

Movement apparatus 1000 has a base structure 1100 and a shelf structure 1200 moveably mounted upon base structure 1100 such that shelf structure 1200 is able to move relative to base structure 1100. Movement apparatus 1000 also has a translation structure 1300 movably mounted to a portion of shelf structure 1200 such that, in the embodiment, it is both slidably and rotatably moveable with respect to shelf structure 1200 as will be discussed in greater detail below. Furthermore, movement apparatus 1000 has a mounting structure 1400 moveably mounted to translation structure 1300 as will be discussed in greater detail below.

In this way, in the embodiment, the mounting structure 1400 is operatively mounted to the base structure 1100 and/or the shelf structure 1200. Similarly, the translation structure 1300 is operatively mounted to the base structure 1200.

Base structure 1100 is formed from two spaced apart guide members 1110 and a pair of spaced support members 1120 extending between the guide members 1110 at respective ends of each. Each guide member 1110 has a channel 1111 located on an outer face thereof.

Base structure 1100 is adapted to be secured to a surface of a vehicle such as a four wheel drive, truck, ute, campervan or the like. Suitably, base structure 1100 is secured by known mechanical fasteners such as bolts, rivets or the like. Alternatively, base structure 1100 may be chemically secured or be secured by way of a weld.

Shelf structure 1200 is moveably mounted upon base structure 1100 so that it is moveable with respect to base structure 1100. In the embodiment, shelf structure 1200 is slidably mounted upon base structure 1100 as will be discussed in greater detail below.

Shelf structure 1200 is formed from a first frame 1210 which, in the embodiment, sits in a plane that is perpendicular to a plane of the base structure 1100. In use, the first frame 1210 sits in a plane that is substantially horizontal. A second frame 1220 is securely fastened to the first frame 1210 at a side thereof. Second frame 1220 extends upwardly from first frame 1210 in a plane that is substantially orthogonal to the plane of the first frame 1210. Second frame 1220 has a guide rail 1221 extending along an outer end of a vertically extending support strut of second frame 1220 as shown.

A shelf member 1230 is secured to first frame 1210 so as to encompass first frame 1210. Furthermore, a wall member 1240 is secured to second frame 1220 so as to encompass second frame 1220.

Shelf structure 1200 also comprises two roller assemblies 1250 secured to a lower side of first frame 1210 with each roller assembly 1250 secured to first frame on opposing sides thereof. Each roller assembly 1250 has a support strut 1251 extending along a respective underside of first frame 1210. Each support strut 1250 also comprises a plurality of rollers 1252 located at spaced intervals along a longitudinal extent thereof.

Rollers 1252 are adapted to be located within channel 1111 of a respective guide member 1110 of base member 1100 to thereby slidably secure shelf structure 1200 to base structure 1100 as will be discussed in greater detail below.

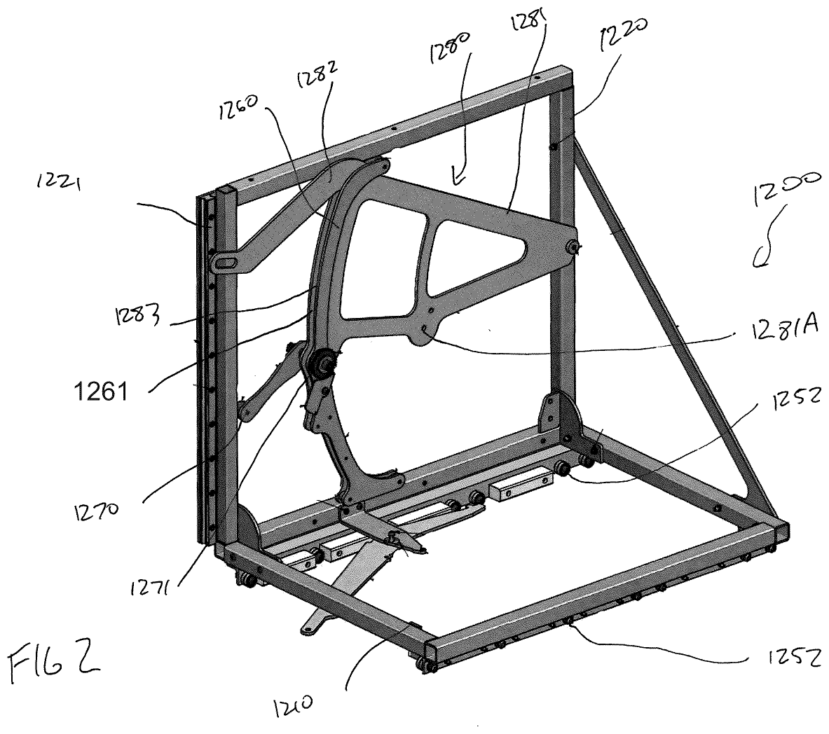

FIG. 2 shows a partial front perspective view of shelf structure 1200. The shelf member 1230 and wall member 1240 are not present in the view shown in FIG. 2.

A guide member 1260 extends between upper and lower struts of second frame 1220 behind wall member 1240 in use as shown. Guide member 1260 is arcuate and has a central channel 1261 extending therethrough. A handle 1270 is attached to a crank shaft 1271 and the crank shaft 1271 extends from one side of guide member 1260 to another such that at least a portion of crank shaft 1271 is located within central channel 1261.

Furthermore, a pivot arm 1280 is rotatably mounted to a vertically extending support strut of second frame 1220 as shown. Pivot arm 1280 has a support portion 1281 and an engagement portion 1282 extending from support portion 1281 at an end distal from end of support portion 1281 rotatably secured to second frame 1220.

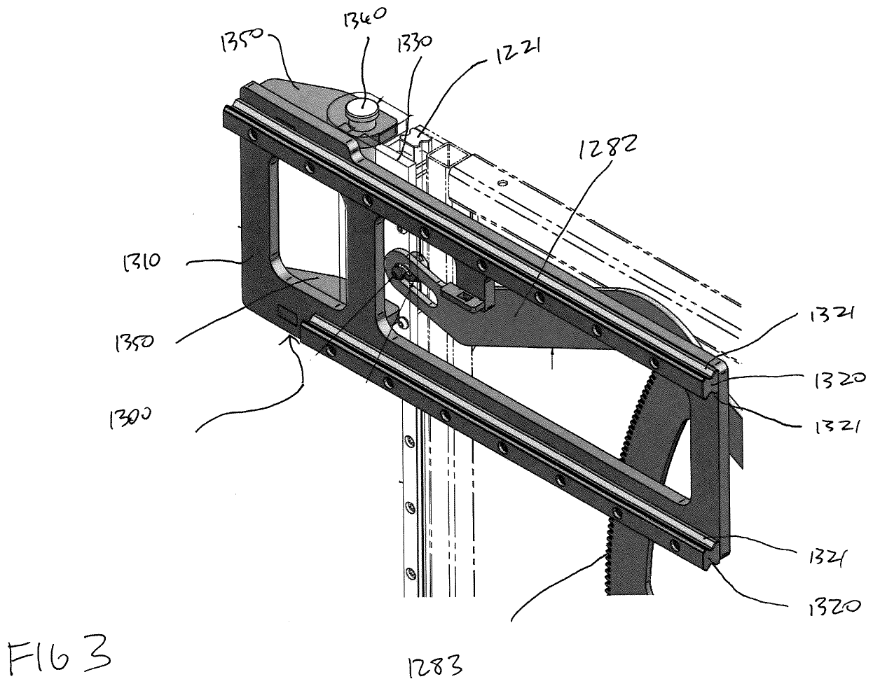

Support portion 1281 has a serrated end portion 1283 (shown most clearly in FIG. 3) located within central channel 1261 of guide member 1260. Serrated end portion 1283 is arcuate so as to map the arc of guide member 1260. Serrated end portion 1283 is configured to engage with crank shaft 1271 such that rotation of handle 1270 causes rotation of pivot arm 1280 about its pivot point. As rotation occurs, serrated end portion 1283 traverses at least a portion of the extent of central channel 1261 of guide member 1260.

Crank shaft 1271 is selectively engageable with serrated end portion 1283 to facilitate the movement described above. Movement of handle 1270 in a direction longitudinal of crank shaft 1271 is operable to move pivot arm 1280 in a direction that is transverse to the plane within which it sits. As such, transverse movement of the pivot arm 1280 moves the pivot arm 1280 between an operable position, whereby rotation of the handle 1270 causes engagement between the crank shaft 1271 and the serrated end portion 1283 to rotate the pivot arm 1280 about its pivot point as previously described, and an inoperative position, whereby crank shaft 1271 is not in engagement with serrated end portion 1283 and, as such, rotation of handle 1270 results in no consequential movement of the pivot arm 1280.

Furthermore, when pivot arm 1280 is in the operable position, engagement portion 1282 engages with movement apparatus 1300 as discussed in greater detail below.

A pneumatic cushion (not shown) as is known in the art extends between pivot arm 1280 at point 1281A and guide portion 1260 at point 1261A. The pneumatic cushion is in the form of a pneumatic cylinder as is known in the art so as to provide a breaking force when serrated end portion 1283 is moving downwardly within central channel 1261.

FIG. 3 shows a partial perspective view of translation structure 1300. Translation structure 1300 is moveably mounted to shelf structure 1200. In particular, in the embodiment, translation structure 1300 is mounted to guide rail 1221 of second frame 1220 and is adapted to rotate with respect to shelf structure 1200 and is also adapted to be slidably moveable along guide rail 1221 as discussed in greater detail below.

Translation structure 1300 has a support web 1310 and a pair of rails 1320 with each rail 1320 located at an upper and lower extent of the support web 1310 as shown. Each rail 1320 has a track 1321 located on an outer extent thereof. The tracks are adapted to receive rollers as discussed in greater detail below.

Translation structure 1300 also has support portions 1350 extending from a rear face of web 1310. A rotation pin 1340 extends through support portions 1350 such that web 1310. A slide portion 1330 is slidably mounted to guide 1221 proximal to each support portion 1350. Rotation pin 1340 extends through each slide portion 1330 so that support portions and web 1310 are rotatable about pin 1340 with respect to slide portion 1350.

The engagement of each slide portion 1350 with guide 1221 facilitates slidable movement of translation structure 1300 with respect to shelf structure 1200. Rotation about pin 1340 facilities rotatable movement of translation structure 1300 with respect to shelf structure 1200.

Furthermore, as pivot arm 1280 moves into the operable position when crank shaft 1271 and serrated end portion 1283 are in engagement, engagement portion 1282 of pivot arm 1280 engages with a slide portion 1350. In this way, as handle 1271 is rotated causing pivot arm 1280 to move within central aperture 1261, engagement of engagement portion 1282 with a slide portion 1350 causes translation structure 1300 to slidably move with respect to shelf structure 1200 by way of engagement of each slide portion 1350 within guide 1221 as previously discussed.

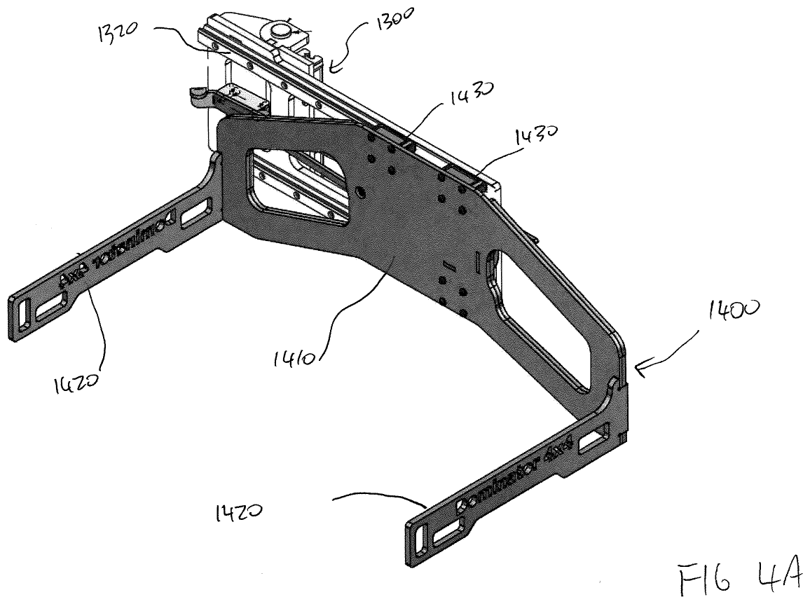

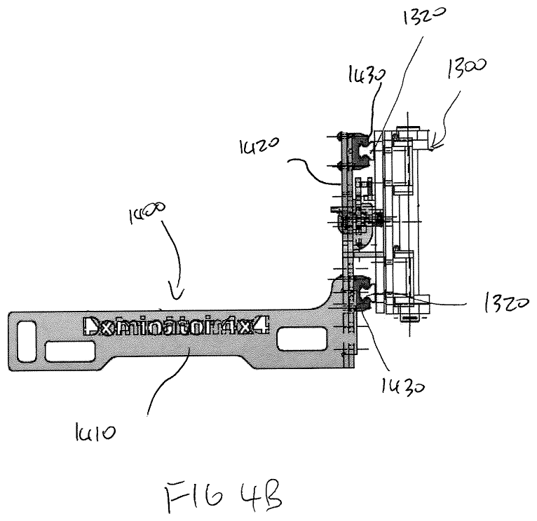

FIG. 4A shows a perspective view of mounting structure 1400 and FIG. 4B shows an end view of mounting structure 1400. Mounting structure 1400 is moveably mounted to translation structure 1300 so that is moveable with respect to translation structure 1300. In the embodiment, mounting structure is slidably mounted to translation structure 1300 as discussed in greater detail below.

Mounting structure 1400 has a web 1410 and a pair of arms 1420 extending outwardly from web 1410. In the embodiment, the arms 1420 are spaced so as to securely receive and locate a fridge 2000 therebetween as shown in FIGS. 1B and 1C. A skilled person will appreciate that mounting structure 1400 may be configured to securely locate different types of items as previously discussed.

Mounting structure 1400 has slider members 1430 extending rearwardly from a rear face of web 1410. Slider members 1430 are configured to engage with a respective rail 1320 to thereby embrace track 1321 to mount mounting structure 1400 to translation structure 1300. Slider members 1430 are moveable along a respective rail 1320 and, in this way, mounting structure 1400 is slidably moveable with respect to translation structure 1300.

As previously described, movement apparatus 1000 is moveable between a storage position and a use position in order that fridge 2000 is moved from a storage location on a vehicle to a use location for convenient access.

FIG. 1A-C show movement apparatus 1000 in the storage position with fridge 2000 securely located within mounting structure. In order to move the movement apparatus 1000 to the use position the mounting structure moves through two distinct intermediate positions in the embodiment.

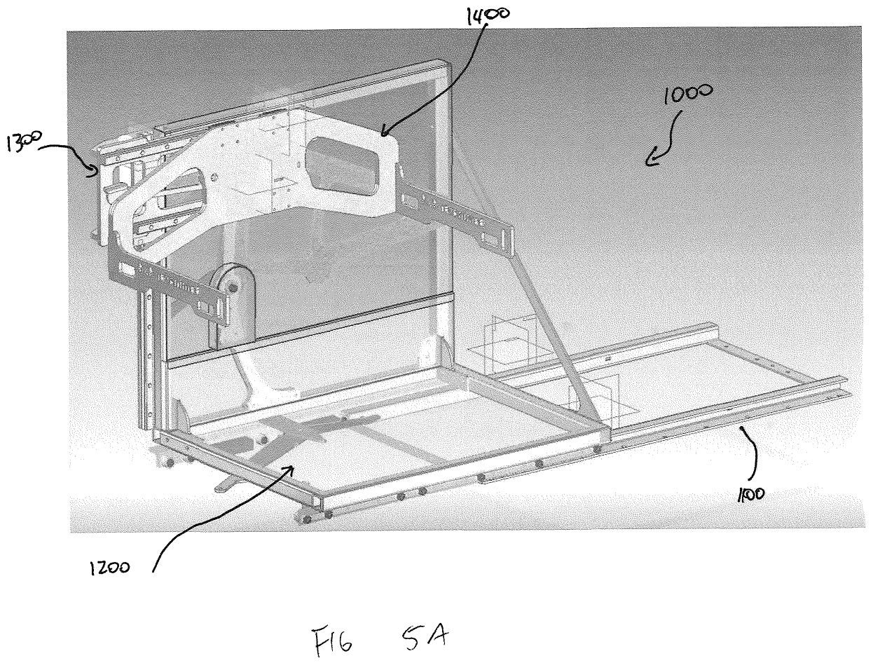

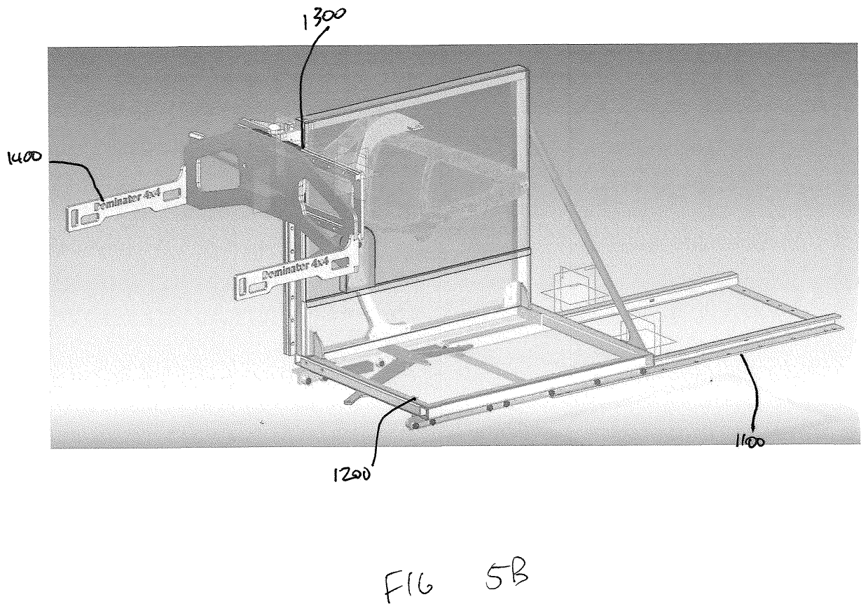

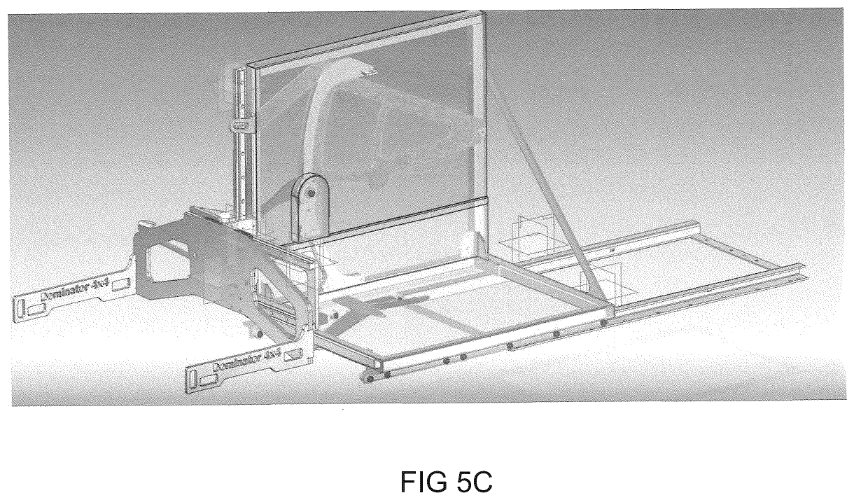

FIG. 5A shows a perspective view of the movement apparatus 1000 in a first intermediate position. As previously described, shelf structure 1200 is slidably mounted on base structure 1100. In this first intermediate position, the shelf structure 1200 has been slidably moved horizontally on base structure 1100 from the storage position. It will be appreciated that in use, this movement moves shelf structure (and thereby operatively the translation structure, the mounting structure 1400 and the item securely received by mounting structure) outward of a storage location of, for example, a ute tray, to a position outside the periphery of the vehicle or the ute.

FIG. 5B shows a perspective view of the movement apparatus 1000 in second intermediate position. As previously described, mounting structure 1400 (and thereby operatively the item) is slidably mounted to translation structure 1300.

Furthermore, as previously described, translation structure 1300 (and thereby operatively mounting structure 1400 and the item securely retained by mounting structure 1400) is rotatably mounted to shelf structure 1200 in the manner previously described.

In order to move from the first intermediate position to the second intermediate position the mounting structure 1400 has been slidably displaced outwardly with respect to the translation structure 1300. Subsequently, the translation structure 1300 has been rotationally displaced with respect to the shelf structure 1200 and the base structure 1100 as shown.

In this way, the mounting structure 1400 securely locating the item has now been displaced outwardly in the same horizontal plane as the one within which it sits in the storage position and then has been subsequently rotationally displaced about a vertical axis with respect to the storage position.

In the embodiment, the rotational displacement is 90 degrees from the storage position but a skilled addressee will appreciate that differing degrees of rotational displacement are contemplated.

FIG. 5C shows a perspective view of the movement apparatus 1000 in the use position. As previously described, translation structure 1300 (and thereby operatively mounting structure 1400 and the item securely retained by mounting structure 1400) is slidably moveable with respect to shelf structure 1200 in the manner previously described.

In order to move from the second intermediate position to the use position, the translation structure 1300 has been vertically displaced, which in use is downwardly displaced, with respect to the shelf structure 1200 and the base structure 1100 as shown.

It will be appreciated from the previous description that this vertical displacement is facilitated by virtue of the crank shaft 1271 is in an inoperative position such that it is not in engagement with serrated end portion 1283 and this pivot arm is not in the operable position. Furthermore, engagement portion 1282 of pivot arm 1280 does not engage with translation structure 1300 as previously discussed. In this way, translation structure 1300 and (operatively mounting structure 1400 and item) is free to be displaced downwardly as described.

In some embodiments, this vertical downward displacement is facilitated by the weight of the item. This movement is controlled by pneumatic cushion (not shown) extending between the points as previously described.

In order to move the movement apparatus 1000 to the second intermediate position, crank shaft 1271 is placed in the operative position such that it is in engagement with serrated end portion 1283 of pivot arm 1280. Furthermore, engagement portion 1282 of pivot arm is placed in engagement with the translation structure 1300. Rotation of the handle 1270 causes rotation of the pivot arm 1280 about its pivot point to thereby displace the mounting structure 1400 and the item vertically upwards towards the second intermediate position.

Conveniently, in the use position, the fridge has been displaced horizontally outside of the vehicle upon which the base structure 1100 has been secured and also has been displaced rotationally about a vertical access and vertically downwards to a convenient height for use of the item. Furthermore, there is advantageously shelf space created by shelf panel 1230. This can be used for all manner pursuits and is advantageous when in a remote location. That desirable shelf space is created by virtue of the rotational displacement of the item and the structures carrying it.

Throughout the specification the aim has been to describe the invention without limiting the invention to any one embodiment or specific collection of features. Persons skilled in the relevant art may realize variations from the specific embodiments that will nonetheless fall within the scope of the invention. For example, individual features from one embodiment may be combined with another embodiment.

It will be appreciated that various other changes and modifications may be made to the embodiment described without departing from the spirit and scope of the invention.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

1. A movement apparatus comprising:
a base; and
a mounting structure operatively mounted to the base and moveable with respect to the base, the mounting structure adapted to securely locate an item;
wherein movement of the mounting structure with respect to the base is operable to move the movement apparatus between a storage position and a use position, whereby in the use position the item securely located on the mounting structure is displaced vertically, horizontally and rotationally from the storage position.

2. The movement apparatus of claim 1 further comprising a shelf structure slidably mounted to the base.

3. The movement apparatus of claim 2, wherein the mounting structure is operatively mounted to the shelf structure, such that the mounting structure is able to be displaced vertically, horizontally and rotationally with respect to the shelf structure and the base.

4. The movement apparatus of claim 2, further comprising a translation structure mounted to the shelf structure, wherein the translation structure is adapted to be rotationally mounted with respect to the shelf structure to enable the translation structure to rotate with respect to the shelf structure.

5. The movement apparatus of claim 4, wherein the translation structure is also adapted to be slidably mounted with respect to the shelf structure to facilitate vertical movement of the translation structure with respect to the shelf structure.

6. The movement apparatus of claim 4, wherein the mounting structure is slidably mounted to the translation structure to thereby be operatively mounted to the base.

7. The movement apparatus of claim 6, wherein the mounting structure is slidably mounted to the translation structure so as to enable the mounting structure to be horizontally displaced with reference to the translation structures.

8. The movement apparatus of claim 1, wherein the movement apparatus is adapted to be moved to a first intermediate position between the storage position and the use position.

9. The movement apparatus of claim 8, wherein in the first intermediate position the item securely located on the mounting structure is displaced horizontally from the storage position.

10. The movement apparatus of claim 9, wherein the movement apparatus is adapted to be moved to a second intermediate position between the first intermediate position and the use position.

11. The movement apparatus of claim 10, wherein in the second intermediate position the item securely located on the mounting structures is further displaced horizontally with respect to the first intermediate position and the storage position and also displaced rotationally with respect to the first intermediate position and the storage position.

12. The movement apparatus of claim 10, wherein the item securely located on the mounting structure is rotationally displaced 90 degrees about a vertical axis.

13. The movement apparatus of claim 10, wherein in the use position the item securely located on the mounting structure is displaced vertically with respect to the second intermediate position, the first intermediate position and the storage position.

14. The movement apparatus of claim 1, wherein the base structure is adapted to be secured to a surface of a vehicle.

15. The moment apparatus of claim 14, wherein in the storage position, the item securely located on the mounting structure is located within the confines of the vehicle.

16. The movement apparatus of claim 14, wherein in the use position, the item securely located on the mounting structure has been displaced outside of the vehicle.
